(19) United States
(12) Patent Application Publication
(10) Pub. No.: US 2025/0306677 A1
(43) Pub. Date: Oct. 2, 2025

(54) SENSOR ASSEMBLY

(71) Applicant: Robert Bosch GmbH, Stuttgart (DE)

(72) Inventor: Johannes Meyer, Haseluenne (DE)

(21) Appl. No.: 18/863,886

(22) PCT Filed: Jan. 8, 2024
(86) PCT No.: PCT/EP2024/050261

§ 371 Date: Nov. 7, 2024

(30) Foreign Application Priority Data
Jan. 24, 2023 (DE) 10 2023 200 505.0

(51) Int. Cl. G06F 3/01

(52) U.S. Cl. CPC G06F 3/014; G06F 3/017

(57) ABSTRACT

A sensor assembly to be attached to an arm of a user. The sensor assembly includes a first laser feedback interferometry sensor, a carrier structure, and a first computing unit. The carrier structure is designed to carry the first laser feedback interferometry sensor on the arm of the user such that the first laser feedback interferometry sensor is designed to detect a position of a first tendon of a back of the hand or of the forearm of the user. The first computing unit is designed to determine a hand gesture of the user depending on the detected position of the first tendon of the back of the hand or of the forearm of the user.

### BACKGROUND INFORMATION

U.S. Pat. No. 11,409,365 B2 describes a sensor assembly to be fastened to a finger of a user of the sensor assembly. The sensor assembly comprises SMI sensors, which are also referred to as laser feedback interferometry sensors. By means of the RFI sensors, gestures, in particular finger gestures, of the user of the sensor assembly can be determined.

### FIELD

The present invention relates to a sensor assembly to be attached to an arm, in particular forearm, of a user. Furthermore, the present invention relates to an optical system for displaying a virtual or augmented reality to a user of the system, and to a method for determining a hand gesture of a user by means of a sensor assembly arranged on an arm, in particular forearm, of the user.

It is an object of the present invention to develop a sensor assembly which determines a hand gesture of the user in a simpler manner.

### SUMMARY

According to the present invention, a sensor assembly to be attached to an arm, in particular forearm, of a user according is provided. Furthermore, an optical system for displaying a virtual or augmented reality to a user of the system, and a method for determining a hand gesture of a user by means of a sensor assembly arranged on an arm, in particular forearm, of the user are provided according to the present invention.

According to an example embodiment of the present invention, the sensor assembly to be attached to an arm, in particular forearm, of a user comprises at least a first laser feedback interferometry sensor. Furthermore, the sensor assembly comprises a carrier structure and a first computing unit. The carrier structure is designed to carry, in particular to attach, the first laser feedback interferometry sensor on the arm, in particular forearm, of the user such that the first laser feedback interferometry sensor is designed to detect a position, in particular a pose, of a first tendon of a back of the hand or of the forearm of the user. The back of the hand has a tendon assigned to each finger. The forearm has a prominent tendon, in particular at the transition to the hand. The first computing unit, in turn, is designed to determine a hand gesture of the user depending on the detected position, in particular pose, of the first tendon of the back of the hand or of the forearm of the user. By detecting the pose or the position of the first tendon, the hand gesture can thus be determined in an accurate and simple manner.

According to an example embodiment of the present invention, preferably, the first laser feedback interferometry sensor is designed to detect a first position, in particular a first pose, of the first tendon of the back of the hand or of the forearm of the user at a first point in time. Furthermore, the first laser feedback interferometry sensor serves to detect a second position, in particular a second pose, of the first tendon of the back of the hand or of the forearm of the user at a second point in time following the first point in time. In this context, the first computing unit is designed to determine the hand gesture of the user depending on the detected first and second positions, in particular poses. Via the thus determined movement of the first tendon, movements can also be detected as hand gestures.

According to an example embodiment of the present invention, preferably, the carrier structure is designed to carry, in particular to attach, the first laser feedback interferometry sensor on the arm, in particular forearm, of the user such that a first light beam emitted by means of the first laser feedback interferometry sensor is emitted toward the back of the hand or the forearm of the user. The emitted first light beam can thus be reflected by the first tendon in the corresponding pose or position back toward the first laser feedback interferometry sensor.

According to an example embodiment of the present invention, preferably, the carrier structure is designed as an armband. In this context, it is preferably provided that the first laser feedback interferometry sensor is integrated on an outer side of the armband. The outer side of the armband refers in particular to the side of the armband that faces away from the skin of the user. This elevated attachment of the first laser feedback interferometry sensor in relation to the arm of the user prevents the first light beams, emitted by means of the first laser feedback interferometry sensor, from possibly being reflected by arm hair of the user. Furthermore, the sensor assembly preferably additionally comprises an, in particular static, deflection unit, which is integrated into the armband and designed to deflect the first light beam, emitted by means of the laser feedback interferometry sensor, toward the back of the hand or the forearm of the user. The deflection unit is in particular a static mirror, which is arranged in a cavity of the first laser feedback interferometry sensor. In this context, the armband preferably also comprises an optical window for outcoupling a first light beam generated by means of the first laser feedback interferometry sensor.

According to an example embodiment of the present invention, preferably, the sensor assembly comprises a plurality of laser feedback interferometry sensors. Each tendon of the back of the hand is assigned at least one laser feedback interferometry sensor. Alternatively or additionally, a further laser feedback interferometry sensor is assigned to at least one tendon of the forearm. In this context, the carrier structure is designed to carry, in particular to attach, each laser feedback interferometry sensor on the arm, in particular forearm, of the user such that each laser feedback interferometry sensor is designed to detect a position, in particular a pose, of a respectively assigned tendon of the back of the hand or of the forearm. This makes it possible to determine even more complex hand gestures with multiple fingers and/or a tilted hand of the user.

According to an example embodiment of the present invention, preferably, the sensor assembly additionally comprises a transmission unit, which is designed to transmit to an optical system the hand gesture of the user that was determined by means of the first computing unit. The optical system, in turn, serves to display contents, in particular image contents, of a virtual or augmented reality to the user of the sensor assembly. This makes it possible to use the determined hand gestures of the user to control virtual image contents of the optical system.

A further object of the present invention is an optical system for displaying a virtual or augmented reality to a user of the system. According to an example embodiment of the present invention, the optical system is preferably a pair of glasses, in particular data glasses, or a pair of virtual reality glasses. The optical system comprises a receiving unit for receiving a hand gesture of the user that was determined by means of a sensor assembly arranged on an arm, in particular forearm, of the user. Alternatively, the receiving unit may also only receive the measurement data detected by means of the sensor assembly. The sensor assembly is in particular the sensor assembly described above. The system comprises a second computing unit, which is designed to control an image content of the virtual or augmented reality depending on the received hand gesture of the user. Alternatively, the second computing unit is designed itself to determine beforehand the hand gesture of the user depending on the received measurement data. For example, in the case of data glasses, a hand tilted downward may indicate that the next virtual image is to be projected into the field of view of the user. A raised index finger of the user may be a pause sign in the case of video data. In connection with virtual reality glasses as an optical system, the second computing unit is preferably designed to control an, in particular virtual, avatar depending on the received hand gesture of the user. In particular, the received hand gesture can be used to control a virtual hand of the avatar such that the virtual hand likewise performs the hand gesture. The received data are used accordingly to model the virtual hand of the avatar, which makes it possible for the user of the optical system to move the hand of the avatar in the virtual world.

A further object of the present invention is a method for determining a hand gesture of a user by means of a sensor assembly arranged on an arm, in particular forearm, of the user.

The sensor assembly is in particular the sensor assembly of the present invention described above. According to an example embodiment of the present invention, in the method, a position, in particular a pose, of a first tendon of a back of the hand or of the forearm of the user is first detected by means of a first laser feedback interferometry sensor of the sensor assembly. Furthermore, the hand gesture of the user is determined by means of a computing unit of the sensor assembly depending on the detected position, in particular pose, of the first tendon of the back of the hand or of the forearm of the user.

According to an example embodiment of the present invention, preferably, a first position, in particular a first pose, of the first tendon of the back of the hand or of the forearm of the user is furthermore detected by means of the first laser feedback interferometry sensor of the sensor assembly at a first point in time. Subsequently, a second position, in particular a second pose, of the first tendon of the back of the hand or of the forearm of the user is furthermore detected by means of the first laser feedback interferometry sensor of the sensor assembly at a second point in time following the first point in time. Furthermore, the hand gesture of the user is determined by means of the first computing unit of the sensor assembly depending on the detected first and second positions, in particular poses, of the back of the hand or of the forearm of the user.

According to an example embodiment of the present invention, preferably, the determined hand gesture is transmitted by means of a transmission unit of the sensor assembly to an optical system in order to display a virtual or augmented reality to the user of the optical system.

According to an example embodiment of the present invention, preferably, the method is performed by a data processing device.

### BRIEF DESCRIPTION OF THE DRAWINGS

FIG. 1 shows a first example embodiment of a sensor assembly to be attached to an arm of a user, according to the present invention.

FIG. 2 shows a second example embodiment of the sensor assembly to be attached to the arm of the user, according to the present invention.

FIG. 3 shows a third example embodiment of the sensor assembly to be attached to the arm of the user and an optical system for displaying a virtual or augmented reality to a user of the system, according to the present invention.

FIG. 4 shows a method for determining a hand gesture of a user of the sensor assembly, according to an example embodiment of the present invention.

### DETAILED DESCRIPTION OF EXAMPLE EMBODIMENTS

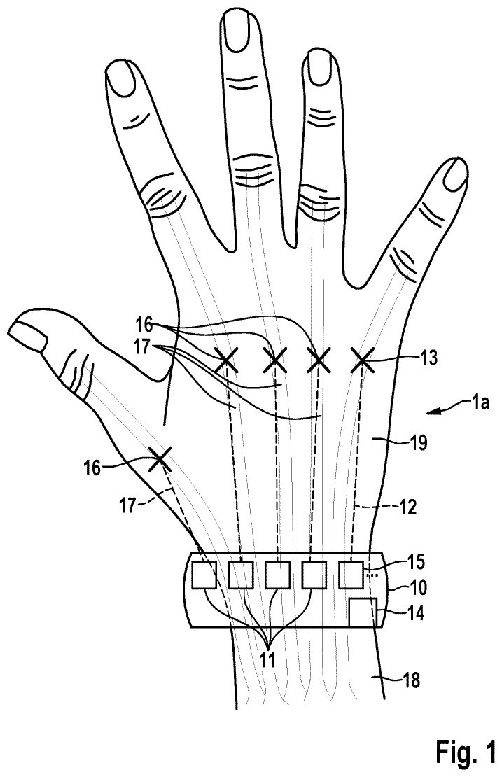

FIG. 1 schematically shows a first embodiment of a sensor assembly 1a to be attached to an arm 18 of a user of the sensor assembly 1a. In this case, the sensor assembly 1a is attached to a forearm at the position of the wrist of the user. The sensor assembly la comprises a first laser feedback interferometry sensor 15, a carrier structure 10 and a first computing unit 14. The carrier structure 14, which in this case is designed as an armband, is designed to carry, in particular to attach, the first laser feedback interferometry sensor 15 on the arm 18 of the user such that the first laser feedback interferometry sensor 15 is designed to detect a position, in particular a pose, of a first tendon 13 of a back 19 of the hand of the user. The first computing unit 14 serves to determine a hand gesture of the user depending on the detected position, in particular pose, of the first tendon 13 of the back 19 of the hand. For this purpose, in this first embodiment, the different positions of the first tendon and the hand gestures respectively assigned to the different positions are stored in the form of a look-up table on the first computing unit 14.

In this first embodiment, the first laser feedback interferometry sensor 15 is designed to detect a first position, in particular a first pose, of the first tendon 13 of the back of the hand at a first point in time. Furthermore, the first laser feedback interferometry sensor 15 serves to detect a second position, in particular a second pose, of the first tendon 13 of the back of the hand at a second point in time following the first point in time. In this context, the first computing unit 14 is in turn designed to determine the hand gesture of the user depending on the detected first and second positions.

In this first embodiment, the carrier structure 10 is furthermore designed to carry, in particular to attach, the first laser feedback interferometry sensor 15 on the arm 19 of the user such that a first light beam 12 emitted by means of the first laser feedback interferometry sensor 15 is emitted toward the back 19 of the hand.

In addition, the sensor assembly la in the first embodiment comprises a plurality of further laser feedback interferometry sensors 11. Each further tendon 16 of the back of the hand is assigned a laser feedback interferometry sensor 11. In this context, the carrier structure 10 is designed to carry, in particular to attach, each further laser feedback interferometry sensor 11 on the arm of the user such that each further laser feedback interferometry sensor 11 is designed to detect a position, in particular a pose, of a respectively assigned tendon 16 of the back 19 of the hand. For this purpose, each further laser feedback interferometry sensor 11 emits a respective further light beam 17 toward the back 19 of the hand or toward the respective tendon 16.

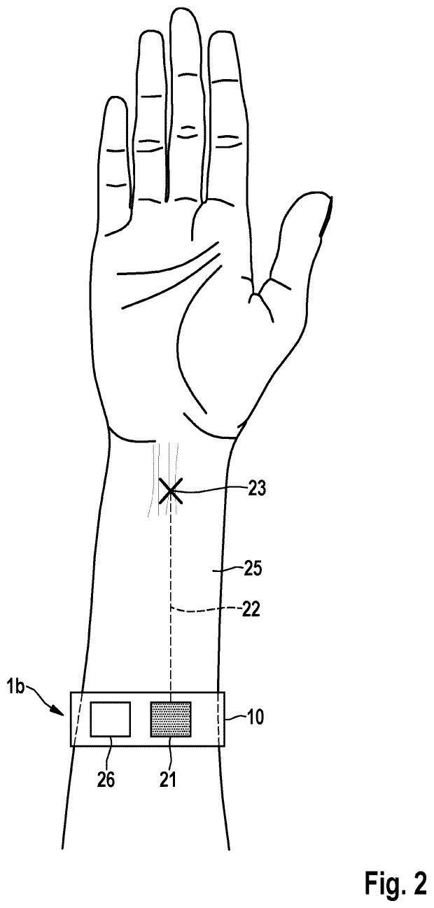

FIG. 2 schematically shows a second embodiment of a sensor assembly 1b to be attached to an arm 25 of a user of the sensor assembly 1b. Here, too, the sensor assembly 1b is arranged on a forearm of the user. In contrast to the first embodiment, a first laser feedback interferometry sensor 21 of the sensor assembly 1b is designed to detect a position, in particular a pose, of a first tendon 23 of the forearm of the user. For this purpose, the first laser feedback interferometry sensor 21 emits first light beams 22 toward the first tendon 23 of the forearm. The first computing unit 26 is in turn designed to determine a hand gesture of the user depending on the detected position, in particular pose, of the first tendon 23 of the forearm of the user.

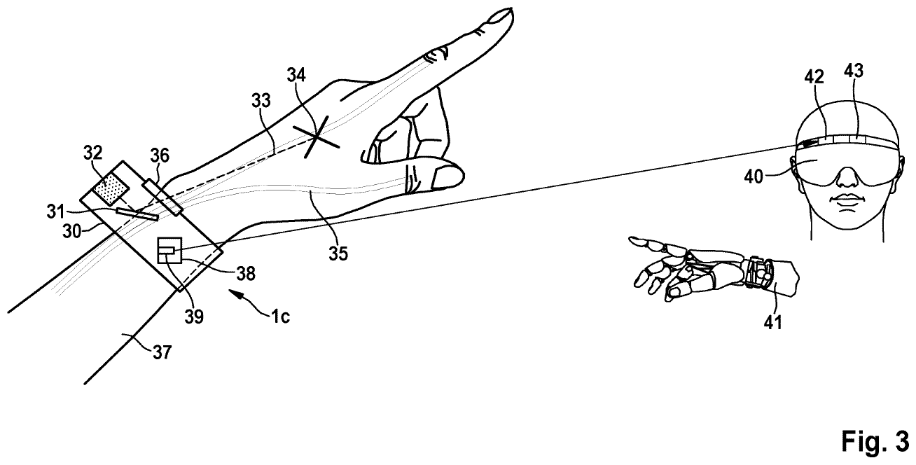

FIG. 3 schematically shows a third embodiment of a sensor assembly 1c to be attached to an arm 37 of the user and an optical system 40 for displaying a virtual or augmented reality to a user of the optical system 40.

The first sensor assembly 1c here also comprises a first laser feedback interferometry sensor 32, a carrier structure 30 in the form of an armband, and a first computing unit 38. The first laser feedback interferometry sensor 32 is integrated as a carrier structure 30 on an outer side of the armband. The sensor assembly additionally comprises an, in particular static, deflection unit 31, which is integrated into the armband and designed to deflect the first light beam 33, emitted by means of the laser feedback interferometry sensor, toward the first tendon 34 of the back 35 of the hand. Furthermore, the sensor assembly 1c comprises an optical window 36 for outcoupling the first light beam. In the embodiment shown, the hand gesture of the user consists of an outstretched index finger, whereby the first tendon 34 protrudes upward in a certain pose or position. The emitted first light beam 33 is reflected back by the first tendon 34 toward the first laser feedback interferometry sensor 32.

Furthermore, the sensor assembly 1c comprises a transmission unit 39, which is designed to transmit to the optical system 40 the hand gesture of the user that was determined by means of the first computing unit 38. The optical system 40, which is designed as a virtual reality here, is designed to display contents, in particular image contents, of a virtual to the user of the sensor assembly 1c. In order to receive the hand gesture or also only the detected measurement values, the optical system 40 comprises a receiving unit 42. Furthermore, the optical system 40 comprises a second computing unit 43, which is designed to control an image content of the virtual reality depending on the received hand gesture of the user. In this context, the second computing unit 43 in this embodiment is designed to control a virtual avatar of the user of the optical system 40 depending on the received hand gesture of the user. The second computing unit 43 is in particular designed to control a hand 41 of the avatar depending on the hand gesture. In particular, the hand of the avatar performs the determined hand gesture and can thus be moved virtually.

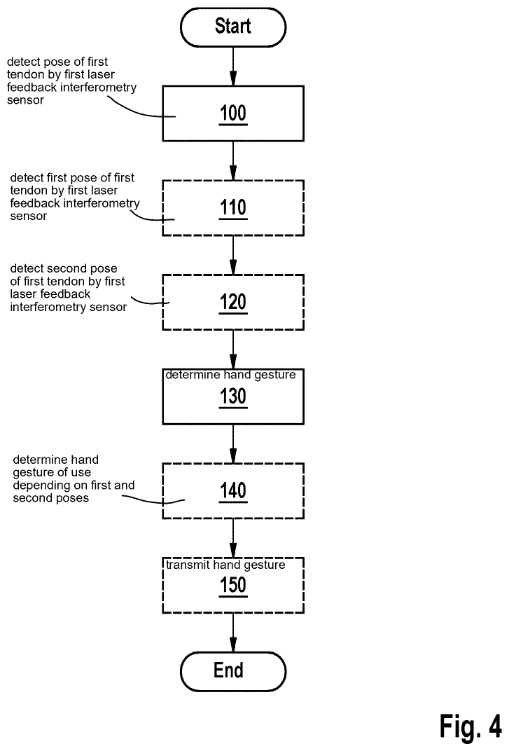

FIG. 4 shows in the form of a flowchart a method for determining a hand gesture of a user by means of a sensor assembly arranged on an arm, in particular forearm, of the user. The sensor assembly is in particular an above-described embodiment of the sensor assembly. In a first method step 100, a position, in particular a pose, of a first tendon of the back of the hand or of the forearm of the user is detected by means of a first laser feedback interferometry sensor of the sensor assembly. In a method step 130 following the method step 100, the hand gesture of the user is determined by means of a first computing unit of the sensor assembly depending on the detected position, in particular pose, of the first tendon of the back of the hand or of the forearm of the user. The method is then terminated.

In an optional method step 110 following the method step 100, a first position, in particular a first pose, of the first tendon of the back of the hand or of the forearm of the user is detected by means of the first laser feedback interferometry sensor of the sensor assembly at a first point in time. In a subsequent method step 120, a second position, in particular a second pose, of the first tendon of the back of the hand or of the forearm of the user is detected by means of the first laser feedback interferometry sensor of the sensor assembly at a second point in time following the first point in time. In a following method step 140, the hand gesture of the user is determined by means of the first computing unit of the sensor assembly depending on the detected first and second positions, in particular poses, of the back of the hand or of the forearm of the user.

In a further optional method step 150, the determined hand gesture is transmitted by means of a transmission unit of the sensor assembly to an optical system for displaying a virtual or augmented reality to the user of the optical system.

1-15. (canceled)

16. A sensor assembly to be attached to a forearm of a user, comprising:
a first laser feedback interferometry sensor;
a carrier structure; and
a first computing unit;
wherein the carrier structure is configured to attach the first laser feedback interferometry sensor on the forearm of the user such that the first laser feedback interferometry sensor is configured to detect a pose of a first tendon of a back of a hand or of the forearm of the user, wherein the first computing unit is configured to determine a hand gesture of the user depending on the detected pose of the first tendon of the back of the hand or of the forearm of the user.

17. The sensor assembly according to claim 16, wherein the first laser feedback interferometry sensor is configured to detect a first pose of the first tendon of the back of the hand or of the forearm of the user at a first point in time, and a second pose of the first tendon of the back of the hand or of the forearm of the user at a second point in time following the first point in time, wherein the first computing unit is configured to determine the hand gesture of the user depending on the detected first and second poses.

18. The sensor assembly according to claim 16, wherein the carrier structure is configured to attach the first laser feedback interferometry sensor on the forearm of the user such that a first light beam emitted by the first laser feedback interferometry sensor is emitted toward the back of the hand or the forearm of the user.

19. The sensor assembly according to claim 16, wherein the carrier structure is configured as an armband.

20. The sensor assembly according to claim 19, wherein the first laser feedback interferometry sensor is integrated on an outer side of the armband.

21. The sensor assembly according to claim 19, wherein the sensor assembly firtjer comprises a static deflection unit integrated into the armband and configured to deflect the first light beam emitted by the laser feedback interferometry sensor toward the back of the hand or the forearm of the user.

22. The sensor assembly according to claim 19, wherein the armband includes an optical window for outcoupling a first light beam generated by the first laser feedback interferometry sensor.

23. The sensor assembly according to claim 19, wherein the sensor assembly comprises a plurality of laser feedback interferometry sensors, wherein: (i) at least one laser feedback interferometry sensor of the plurality of laser feedback interferometry sensors is assigned to each tendon of the back of the hand and/or (ii) a further laser feedback interferometry sensor is assigned to at least one tendon of the forearm, wherein the carrier structure is configured to attach each of the laser feedback interferometry sensorson the forearm of the user such that each laser feedback interferometry sensor is configured to detect a pose of a respectively assigned tendon of the back of the hand or of the forearm.

24. The sensor assembly according to claim 16, wherein the sensor assembly further comprises a transmission unit, wherein the transmission unit is configured to transmit the hand gesture of the user that was determined by using the first computing unit, to an optical system, which is configured to display image contents of a virtual or augmented reality to the user of the sensor assembly.

25. An optical system for displaying a virtual or augmented reality to a user of the system, the system comprising:
a receiving unit configured to receive a hand gesture of the user that was determined by a sensor assembly arranged on a forearm of the user, the sensor assembly including:
a first laser feedback interferometry sensor,
a carrier structure, and
a first computing unit,
wherein the carrier structure is configured to attach the first laser feedback interferometry sensor on the forearm of the user such that the first laser feedback interferometry sensor is configured to detect a pose of a first tendon of a back of a hand or of the forearm of the user, wherein the first computing unit is configured to determine a hand gesture of the user depending on the detected pose of the first tendon of the back of the hand or of the forearm of the user; and
a second computing unit configured to control an image content of the virtual or augmented reality depending on the received hand gesture of the user.

26. The optical system according to claim 25, wherein the second computing unit is configured to control a virtual avatar depending on the received hand gesture of the user.

27. The optical system according to claim 25, wherein the optical system is a pair of glasses.

28. A method for determining a hand gesture of a user using a sensor assembly arranged on a forearm, of the user, the method comprises the following method steps:
detecting a pose of a first tendon of a back of a hand or of the forearm of the user by a first laser feedback interferometry sensor of the sensor assembly; and
determining the hand gesture of the user depending on the detected pose of the first tendon of the back of the hand or of the forearm of the user using a first computing unit of the sensor assembly.

29. The method according to claim 28, further comprising the following steps:
detecting a first pose of a first tendon of the back of the hand or of the forearm of the user using the first laser feedback interferometry sensor of the sensor assembly at a first point in time;
detecting a second pose of the first tendon of the back of the hand or of the forearm of the user using the first laser feedback interferometry sensor of the sensor assembly at a second point in time following the first point in time; and
determining the hand gesture of the user depending on the detected first and second poses of the back of the hand or of the forearm of the user using the first computing unit of the sensor assembly.

30. The method according to claim 28, further comprising the following step:
transmitting the determined hand gesture using a transmission unit of the sensor assembly to an optical system in order to display a virtual or augmented reality to the user of the optical system.
